(19) United States
(12) Patent Application Publication
(10) Pub. No.: US 2011/0085172 A1
(43) Pub. Date: Apr. 14, 2011

(54) VISUALIZED PLASMON RESONANCE BIODETECTOR

(76) Inventors: Ta-Jen YEN, Hsinchu County (TW); Hsin-Yun Chang, Taichung City (TW); Chung-Tien Li, Tainan County (TW)

(21) Appl. No.: 12/970,391

(22) Filed: Dec. 16, 2010

Related U.S. Application Data
(63) Continuation-in-part of application No. 12/387,336, filed on Apr. 30, 2009.

(51) Int. Cl. G01N 21/55

(52) U.S. Cl. 356/445

(57) ABSTRACT

A visualized plasmon resonance biodetector utilizes the surface plasmon resonance to detect a plurality of biochemical molecules, and comprises a substrate, a silver-gold dual-layer structure, and a visible light source. The silver-gold dual-layer structure is formed on the substrate and has an optical grating structure on one side far away from the substrate. In a test, the biochemical molecule combines with the silver-gold dual-layer structure, and the visible light source emits a visible light to illuminate the substrate. Then the silver-gold dual-layer structure on the substrate generates surface plasmon resonance and a reflected light. The user can use his naked eyes to discriminate the reflected lights and learn the component and concentration of the biochemical molecule. Therefore, the biodetector can provide a low-cost and easy-to-operate detection instrument for biotests.

This application is a continuation-in-part, and claims priority, of from U.S. patent application Ser. No. 12/387,336 filed on Apr. 30, 2009, entitled “VISUALIZED PLASMON RESONANCE BIODETECTOR”

### FIELD OF THE INVENTION

The present invention relates to a biodetector, particularly to a visualized plasmon resonance biodetector.

### BACKGROUND OF THE INVENTION

In the conventional surface plasmon resonance detector, a probe is connected to a gold-coated glass. When a specimen passes through the detector, the surface refractivity and the resonant angle are changed if the specimen contains a material able to combine with the probe. The variation of the resonant angle thus determines whether there is a material able to combine with the probe in the specimen. Further, the value of the resonant angle variation correlates with the quantity of the material combining with the probe. Therefore, the plasmon resonance detector can also be used in quantitative analysis. The plasmon resonance technology can undertake instant and successive tests without labeling the specimens. The reason why gold is coated on glass is that low surface activity of gold implies high biocompatibility. Further, when gold nanoparticles are used in the plasmon resonance technology, the frequency of surface plasmon resonance varies with the fabrication technology. Thus, the plasmon resonance detector can present different visible colors and extensively apply to biotests.

The surface plasmon resonance technology has very high resolution. However, it needs a high optical precision spectrometer and a high mechanical precision angle analyzer. Therefore, only research organizations or medical laboratories/manufacturers can afford it. The common hospitals and clinics are hard to use the expensive technology but still use the PCR (Polymerase Chain Reaction)-based technologies now, including PCR, RT-PCR (Reverse Transcription PCR), electrophoresis, and gene sequencing. The PCR-based technologies are cheaper and highly sensitive. However, the operation procedures thereof are so complicated that common personnel cannot undertake the PCR-based tests, and only the fully-trained personnel can correctly undertake the PCR-based tests. Sometimes, the protein of the gene of a specimen is hard to duplicate. Thus, the PCR-based technologies cannot detect the protein of a very low concentration at a high sensitivity.

U.S. Pat. No. 7,271,914 discloses “BIOMOLECULAR SENSOR SYSTEM UTILIZING A TRANSVERSE PROPAGATION WAVE OF SURFACE PLASMON RESONANCE”, which includes a substrate, a dielectric layer, a sensing film and a pair of prism devices. The sensing film is disposed in a groove of the dielectric layer, and the prism devices separating a tunable distance are arranged on two sides of the groove respectively. A resonance light is reflected and passes through the prism device into the light detector to be analyzed. However, the system has disadvantages such as a large volume of the prism device, complexity of modifying the arrangement and hard to adjust.

### SUMMARY OF THE INVENTION

One objective of the present invention is to provide a high-precision and easy-to-operate visualized plasmon resonance biodetector.

To achieve the abovementioned objective, the present invention proposes a visualized plasmon resonance biodetector, which utilizes the surface plasmon resonance to detect a plurality of biochemical molecules, and which comprises a substrate, a silver-gold dual-layer structure, and a visible light source. The silver-gold dual-layer structure is formed on the substrate and has an optical grating structure on one side far away from the substrate, and the optical grating structure is formed by arranging a plurality of protrusions in a periodic manner. The silver-gold dual-layer structure can combine with a biochemical molecule. The visible light source emits a visible light to illuminate the silver-gold dual-layer on the substrate, whereby the silver-gold dual-layer structure creates surface plasmon resonance and generates a reflected light.

Via the abovementioned technical scheme, the visualized plasmon resonance biodetector of the present invention has the following advantages:

1. In the present invention, the visible light source adopts a white light source with wavelengths ranging from 400 to 750 nm, and the white light source may be realized with a common white light LED (Light Emitting Diode). The present invention needn't use any special optical energy detector. Therefore, the present invention is a low-cost and easy-to-operate detector for common hospitals and clinics.

2. As the surface of conventional gold nanoparticles can combine with the ligands and the thio groups by weak bonding, the surface of gold nanoparticles is easy to modify. The surface plasmon band of silver can absorb photons with wavelengths ranging from 390 to 400 nm, and silver has an absorption coefficient four times higher than that of gold. Thus silver is an ideal material for biotest. The present invention integrates the advantages of gold and silver to promote the sensitivity of the biodetector.

### BRIEF DESCRIPTION OF THE DRAWINGS

FIG. 1 is a diagram schematically showing the structure of a visualized plasmon resonance biodetector according to one embodiment of the present invention;

FIG. 2 is a diagram schematically showing the structure of a visualized plasmon resonance biodetector according to another embodiment of the present invention;

FIG. 3 is a diagram showing the curves of the test results, wherein the visualized plasmon resonance biodetector according to the present invention adopts a 35 nm silver film and a 5 nm gold film to test a first group of solutions;

FIG. 4 is a diagram showing the reflected lights in the test, wherein the visualized plasmon resonance biodetector according to the present invention adopts a 35 nm silver film and a 5 nm gold film to test the first group of solutions;

FIG. 5 is a diagram showing the curves of the test results, wherein the visualized plasmon resonance biodetector according to the present invention adopts a 35 nm silver film and a 5 nm gold film to test a second group of solutions;

FIG. 6 is a diagram showing the reflected lights in the test, wherein the visualized plasmon resonance biodetector according to the present invention adopts a 35 nm silver film and a 5 nm gold film to test the second group of solutions; and

FIG. 7 is a diagram showing the test results, wherein the visualized plasmon resonance biodetector according to the present invention adopts a 35 nm silver film and a 5 nm gold film to perform another biotest.

### DETAILED DESCRIPTION OF THE PREFERRED EMBODIMENTS

Below, the technical contents of the present invention are described in detail in cooperation with the embodiments. However, it should be understood that the embodiments are only to exemplify the present invention but not to limit the scope of the present invention.

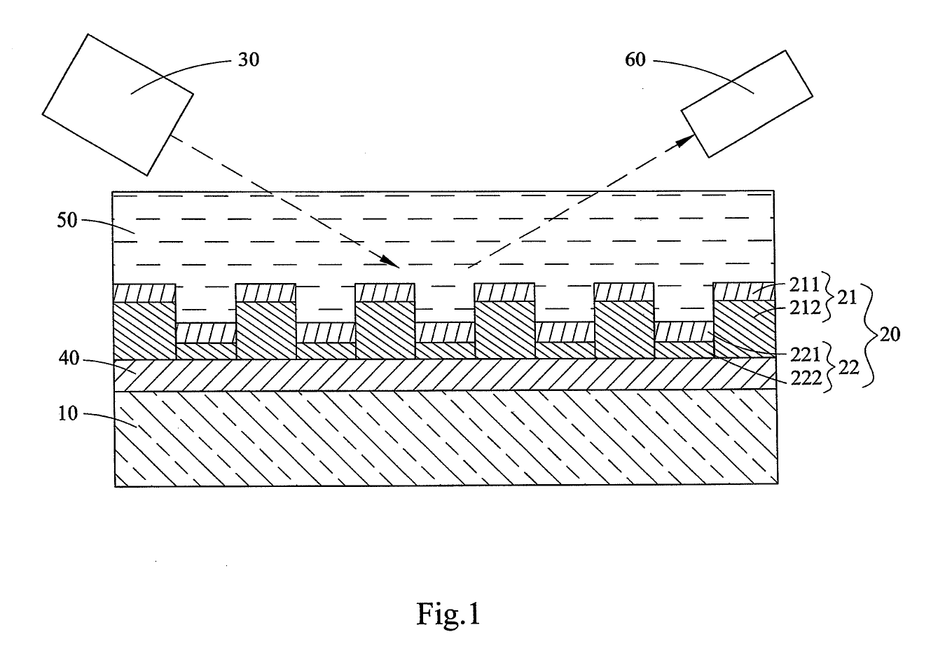

Refer to FIG. 1 a diagram schematically showing the structure of a visualized plasmon resonance biodetector according to one embodiment of the present invention. The visualized plasmon resonance biodetector of the present invention utilizes surface plasmon resonance to detect a plurality of biochemical molecules and comprises a substrate 10, a silver-gold dual-layer structure 20, and a visible light source 30. The substrate 10 is made of a glass. The silver-gold dual-layer structure 20 has an optical grating structure on one side far away from the substrate 10, which is formed by arranging a plurality of protrusions in a periodic manner. In this embodiment, the silver-gold dual-layer structure 20 has a plurality of thick elements 21 and a plurality of thin elements 22. The thick elements 21 and thin elements 22 are arranged alternately to form the optical grating structure. The thick element 21 has a silver layer 212 and a gold layer 211. The thin element 22 has a silver layer 222 and a gold layer 221. The silver layers 212 and 222 are adjacent and arranged on the substrate 10. The gold layers 211 and 221 are arranged on surfaces of the silver layers 212 and 222, which are far away from the substrate 10. The silver layer 212 of the thick element 21 has a thickness of 38 nm. The silver layer 222 of the thin element 21 has a thickness of 5 nm. Both the gold layers 211 and 221 of the thick element 21 and thin element 22 have a thickness of 5 nm. Experimental results prove that the gold layers 211 and 221 and silver layers 212 and 222 with the abovementioned ratios of thicknesses have very high sensitivity. Further, the gold layers 211 and 221 can protect the silver layer 212 and 222 from oxidization and sulfuration. Furthermore, an adhesion layer 40 is pre-coated between the substrate 10 and the silver-gold dual-layer structure 20 to improve adhesion of the silver-gold dual-layer structure 20 to the substrate 10 and facilitate recycling of the present invention. The adhesion layer 40 is made of titanium, chromium, aluminum, or a combination thereof. In a biotest, the silver-gold dual-layer structure 20 receives a biochemical molecule 50, and the visible light source 30 emits light through the biochemical molecule 50 to the substrate 10. In this embodiment, the biochemical molecule 50 is accommodated by the substrate 10 in form of liquid; the visible light source 30 is a white light source emitting a light with wavelengths of 400-750 nm. The light emitted by the visible light source 30 reacts with the silver-gold dual-layer structure 20 to generate a reflected light to a detector 60. The detector 60 may be a camera capturing images for computer processing. The detector 60 may be human eyes directly observing color variation to determine the biotest result. The present invention is stressed on using human eyes' observation to determine biotest results.

It should be mentioned particularly: The present invention uses an optical grating structure as the coupling device to excite surface plasmon resonance. The resonance behavior in grating coupling is more complicated than prism coupling and needs a simulation to find out appropriate parameters. The optical path of the grating coupling is more difficult than the angle detection of the prism coupling because white light is not a collimated light source but has a dispersion phenomenon. Therefore, the design of an optical grating structure must take into consideration the incident light, the used metallic material and the incident angle so as to successfully excite surface plasmon resonance. In the abovementioned embodiment, the resonance wavelength will not fall in the range of visible light unless the optical grating structure containing the thick elements 21 and thin elements 22 has a period of 400-1000 nm, wherein the period is equal to the sum of the widths of one thick element 21 and one thin element 22. The drawings do not depict the thick elements 21 and the thin elements 22 by correct proportion by only show them schematically.

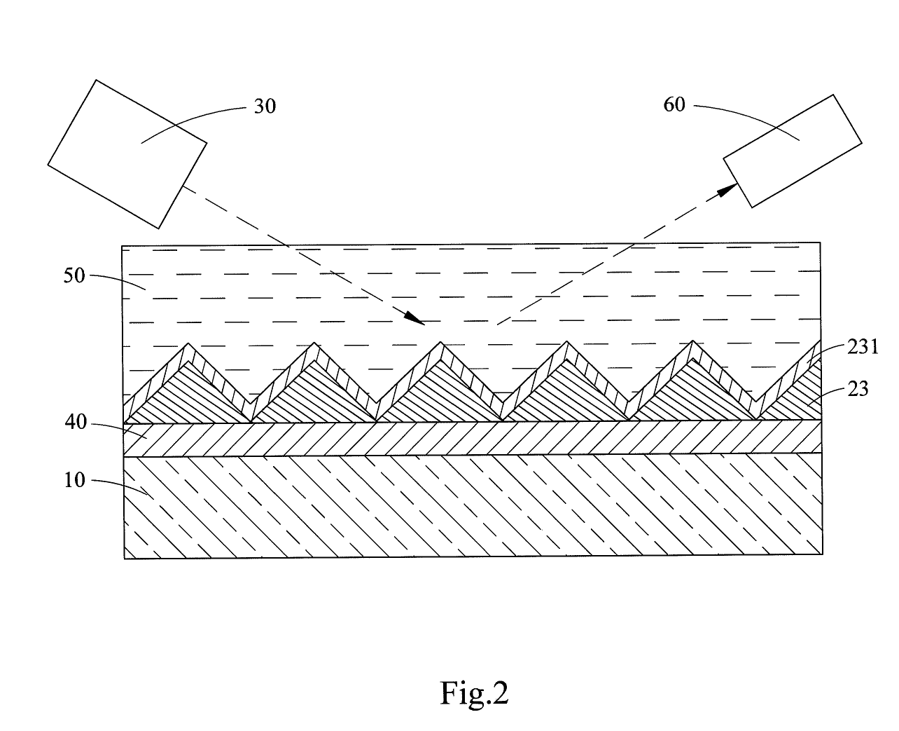

Refer to FIG. 2 a diagram schematically showing the structure of a visualized plasmon resonance biodetector according to another embodiment of the present invention. In this embodiment, the silver-gold dual-layer structure 20 has a plurality of triangular elements 23 adjacent with each other arranged on the substrate 10 to form an optical grating. The triangular elements 23 are made of silver and have a gold layer 231 on the side far away from the substrate 10 to form a silver-gold dual-layer structure 20 functioning as a raster structure.

In the present invention, the gold layers 211, 221 and 231 are made of gold nanoparticles, which have the following advantages:

(1) The surface of gold nanoparticles can combine with the charged ligands and the charged thio groups by weak bonding, and the surface of gold nanoparticles is thus easy to modify. Then, the functional groups at the ends of biochemical molecules can combine with gold nanoparticles. Therefore, gold nanoparticles have low surface activity and high biocompatibility.

(2) When gold nanoparticles apply to the surface plasmon resonance technology, they can present different colors.

(3) The diameter of gold nanoparticle is easy to control and ranges from few to 100 nm.

Due to the abovementioned advantages, gold nanoparticles are extensively used in biotest technologies.

The silver nanoparticles in the silver layers 212, 222 and 23 have two characteristics:

(1) The surface plasmon band of silver nanoparticles can absorb photons with wavelengths ranging from 390 to 400 nm.

(2) Silver nanoparticles have an absorption coefficient four times higher than that of gold nanoparticles.

In the present invention, the silver-gold dual-layer structure 20 is formed on the substrate 10 via an electron-gun vapor deposition method. The present invention employs the biocompatibility and the color response in plasmon resonance of the gold layers 211 and 221 and the surface plasmon resonance feature of the silver layers 212 and 222 to construct the high-biosensitivity and high-precision biodetector. Before forming the silver-gold dual-layer structure 20, the present invention can pre-coat a adhesion layer 40 on the substrate 10 overcome the irreversibility problem of gold nanoparticles, improve the adhesion of the gold layers 211 and 221 and enable the repeated use of the biodetector.

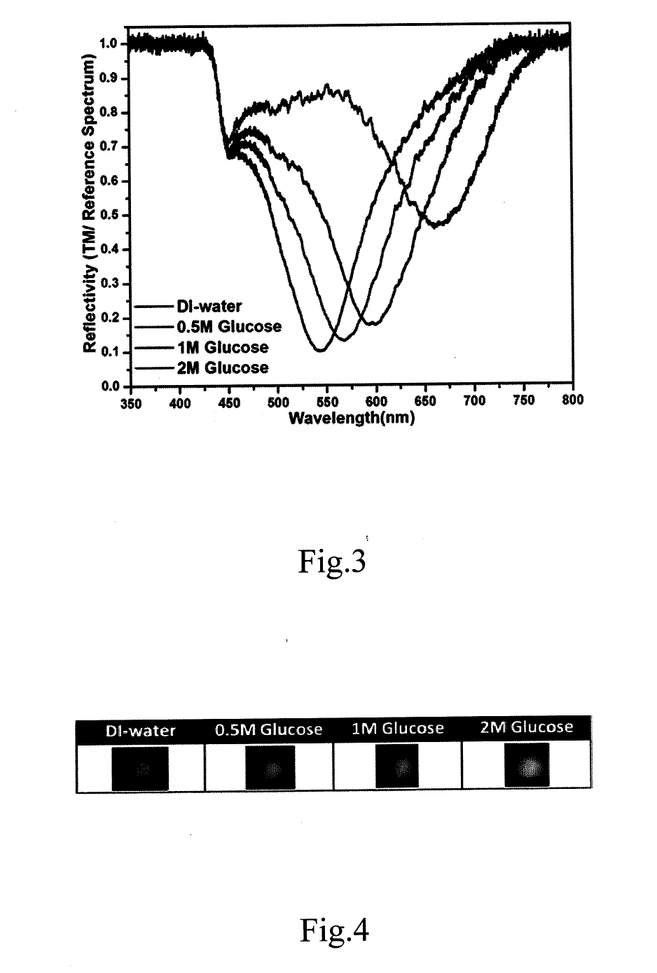

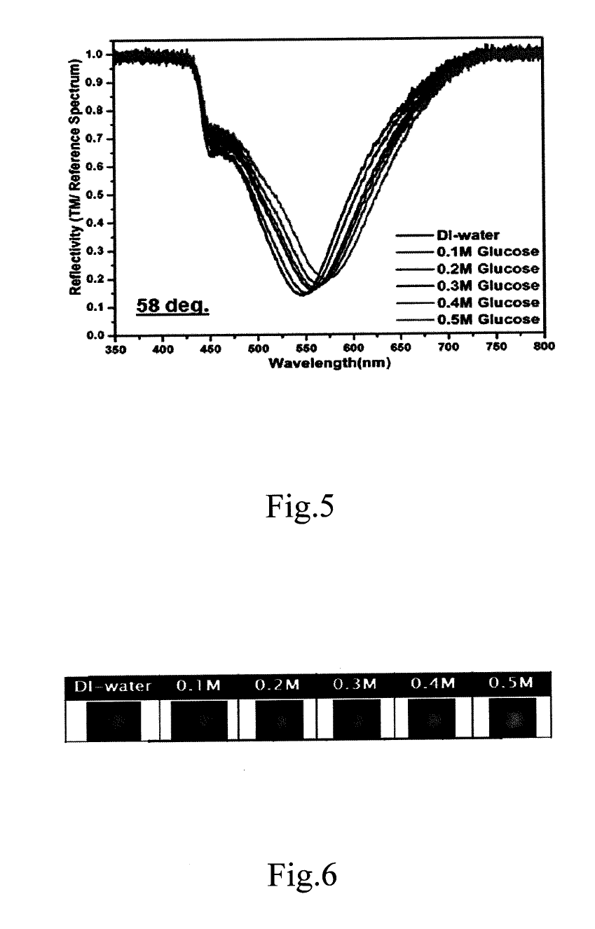

Refer FIG. 3 and FIG. 4 for the results of tests using the present invention, wherein the present invention adopts a 35 nm silver layer and a 5 nm gold layer to test a first group of solutions containing DI (deionized) water, 0.5M, 1M and 2M glucose solutions. In FIG. 3, different V-shape curves represent that the visible light source 30 is absorbed by the silver-gold dual-layer structure 20 different concentrations of solutions. In FIG. 4, the wavelengths of the reflected lights are within the visible-light spectrum ranging from 400 to 750 nm and present different colors for different concentrations of solutions. Refer to FIG. 5 and FIG. 6 for the results of tests using the present invention, wherein the present invention adopts a 35 nm silver layer and a 5 nm gold layer to test a second group of solutions containing DI (deionized) water, 0.1M, 0.2M, 0.3M, 0.4M and 0.5M glucose solutions. It is known from FIG. 3, FIG. 4, FIG. 5, FIG. 6 that even smaller concentration difference can also be discriminated by the present invention.

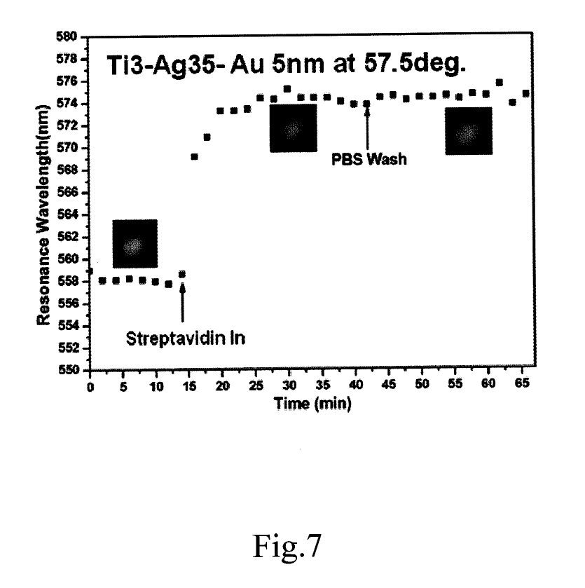

Refer to FIG. 7 for the results of tests using the present invention, wherein the present invention adopts a 35 nm silver layer and a 5 nm gold layer to test the specific binding reaction between biotin and streptavidin. It proves that the present invention can create a binding condition for the silver-gold dual-layer structure 20 and another biochemical molecule to implement another biotest.

In conclusion, the present invention uses the design integrating the silver-gold dual-layer structure 20 and the visible light source 30 to undertake biotests and present biotest results visible for human eyes. The present invention can discriminate very small difference of concentrations. The present invention can create a binding condition for the silver-gold dual-layer structure 20 and a different biochemical molecule to implement a different biotest. The primary advantage of the present invention is that optical grating coupling has much higher integrability than prism coupling. As the visualized plasmon resonance biodetector of the present invention needn't use prisms, it can save cost and space. The present invention needn't use a special optical detector to analyze the detection outputs. Further, the present invention needn't adjust the angle to detect wavelength and thus needn't use an angle-adjust table, which can further save space and cost. Furthermore, the white light source of the present invention adopts a common LED, which is much cheaper than a laser device usually used in angle detection. The present invention not only can save cost and space but also can use the surface plasmon resonance to achieve high-precision detection. Therefore, the present invention can provide a low-cost and easy-to-operate detection instrument for common hospitals and clinics. In the present invention, the silver layers 212, 222 and 23 having a high absorption coefficient cooperates with the gold layers 211, 221 and 231 to promote the sensitivity of the biodetector. Moreover, the present invention uses an adhesion layer 40 to enhance the adhesion of the gold layers 211, 221 and 231 and enable the repeated use of the biodetector, whereby the cost of biotests is further reduced.

What is claimed is:

1. A visualized plasmon resonance biodetector, which utilizes surface plasmon resonance to detect a plurality of biochemical molecules, comprising:
a substrate;
a silver-gold dual-layer structure formed on said substrate and having an optical grating structure on one side far away from the substrate, and the optical grating structure being formed by arranging a plurality of protrusion in a periodic manner; and
a visible light source emitting a visible light to illuminate the substrate and react with the silver-gold dual-layer structure to generate a reflected light.

2. The visualized plasmon resonance biodetector according to claim 1, wherein the substrate is made of glass.

3. The visualized plasmon resonance biodetector according to claim 1, wherein silver layers and gold layers are sequentially deposited on the substrate with an electron-gun vapor deposition method to form the silver-gold dual-layer structure.

4. The visualized plasmon resonance biodetector according to claim 3, wherein an adhesion layer is pre-coated between the substrate and the silver-gold dual-layer structure.

5. The visualized plasmon resonance biodetector according to claim 4, wherein the adhesion layer is made of a material selected from a group consisting of titanium, aluminum, chromium and a combination thereof.

6. The visualized plasmon resonance biodetector according to claim 1, wherein the silver-gold dual-layer structure has a plurality of thick elements and thin elements, which are arranged alternately to form the optical grating structure.

7. The visualized plasmon resonance biodetector according to claim 6, wherein the thick element and the thin element have silver layers and gold layers, and wherein the silver layers are adjacent and arranged on the substrate, and the gold layers are arranged on one side of the silver layers, which are far away from the substrate.

8. The visualized plasmon resonance biodetector according to claim 7, wherein the silver layer of the thick element has a thickness of 38 nm, and wherein the silver layer of the thin element has a thickness of 5 nm, and wherein the gold layer of both the thick element and thin element have a thickness of 5 nm.

9. The visualized plasmon resonance biodetector according to claim 7, wherein the optical grating structure containing the thick elements and the thin elements has a period of 400-1000 nm.

10. The visualized plasmon resonance biodetector according to claim 1, wherein the silver-gold dual-layer structure has a plurality of triangular elements adjacent with each other arranged on the substrate to form the optical grating structure with a serrate surface.

11. The visualized plasmon resonance biodetector according to claim 10, wherein the triangular elements are made of silver and have a gold layer on one side thereof, which is far away from the substrate.

12. The visualized plasmon resonance biodetector according to claim 1, wherein the visible light source emits light having wavelengths of 400-750 nm.
